(19) United States
(12) Patent Application Publication
(10) Pub. No.: US 2022/0398048 A1
(43) Pub. Date: Dec. 15, 2022

(54) FILE STORAGE SYSTEM AND MANAGEMENT INFORMATION FILE RECOVERY METHOD

(71) Applicant: Hitachi, Ltd., Tokyo (JP)

(72) Inventors: Yuto KAMO, Tokyo (JP); Mitsuo HAYASAKA, Tokyo (JP); Shimpei NOMURA, Tokyo (JP)

(73) Assignee: Hitachi, Ltd., Tokyo (JP)

(21) Appl. No.: 17/691,464

(22) Filed: Mar. 10, 2022

(30) Foreign Application Priority Data
Jun. 11, 2021 (JP) 2021-098032

(51) Int. Cl. G06F 3/06

(52) U.S. Cl. CPC G06F 3/0667; G06F 3/067; G06F 3/0647; G06F 3/0653; G06F 3/0614; G06F 3/0638

(57) ABSTRACT

In order to quickly recover a management information file, an Edge file storage stores user files and a management information file that manages management states of the user files in the Edge file storage. The Edge file storage manages operation logs indicating operation contents concerning user files accepted by nodes in association with the respective nodes. The Edge file storage extracts operation logs for a user file associated with a targeted management information file as a management information file stored in a failed node from the operation logs corresponding to the nodes. The Edge file storage aggregates operation logs that are extracted from the operation logs corresponding to the nodes and are used for the user file associated with the targeted management information file. The Edge file storage recovers the targeted management information file based on the aggregated operation log.

### BACKGROUND

The present invention relates to a technique to recover a management information file that manages states of files in a file storage system.

There is an increasing need for systems that utilize data by linking it between sites such as hybrid clouds and multi-clouds. The file virtualization function is a technology that responds to the need and allows files containing real data at other sites to appear to exist at a local site. The file virtualization function provides a management information file that manages real data positions corresponding to each user file. For example, the file virtualization function includes a function to detect, in units of bytes, data of files generated or updated in Edge storage and asynchronously migrate the data to a datacenter; a stubbing function to delete files not accessed by a client from the storage; and a recall function to acquire target data from the datacenter when re-referenced by the client.

There is an increase in the amount of data stored in the file storage system every year. The file storage system needs to be scalable.

File storage systems being used provide the file virtualization function for a distributed file system composed of multiple nodes.

For example, some of these file storage systems protect data in the block layer but not in the file layer. Such a file storage system guarantees block-based consistency, but not file-based consistency if a failure such as a power failure occurs at a node configuring the distributed file system.

A node failure may cause inconsistency between the state of a user file and the information in the management information file. File input or output from this user file is unavailable until the management information file is recovered.

For example, U.S. Pat. No. 7,660,832 describes the technology that determines a point to recover from the recovery point in the event of a system failure, restores the volume from a created backup, and rewrites metadata to maintain the data consistency.

### SUMMARY

For example, if the file storage system fails, a possible solution is to recover the management information file by using an operation log for each node. However, an increase in the number of nodes causes voluminous operation logs, increases the time to recover the management information file, and degrades the availability of the file storage system.

The present invention has been made in consideration of the foregoing. It is therefore an object of the invention to provide a technology capable of fast recovering a management information file.

To achieve the above-described object, a file storage system according to one aspect is composed of multiple nodes each including a processor and a storage device and includes a first storage system that manages a user file used by a client by distributing the user file to multiple nodes; and a second storage system that is connected to the first storage system via a network and provides a file virtualization function for files managed by the first storage system in conjunction with the first storage system. The first storage system stores a user file and a management information file that manages management states of the user files in the first storage system. The first storage system manages an operation log storing operation contents of the user file accepted by each node in association with each node. The first storage system extracts, from each operation log corresponding to each node, operation contents concerning a user file associated with a targeted management information file as a management information file stored in a failed node. The first storage system aggregates operation contents, being extracted from each operation log corresponding to each node and used for a user file associated with the targeted management information file, and recovers the targeted management information file based on aggregated operation contents.

The present invention can fast recover the management information file.

### BRIEF DESCRIPTION OF THE DRAWINGS

FIG. 1 illustrates an overview of normal processing of the file storage system according to an embodiment;

FIG. 2 illustrates an overview of processing during a failure recovery of the file storage system according to an embodiment;

FIG. 3 illustrates a configuration diagram of the file storage system according to an embodiment;

FIG. 4 illustrates a configuration diagram of Edge file storage according to an embodiment;

FIG. 5 illustrates an configuration diagram of object storage according to an embodiment;

FIG. 6 illustrates a configuration diagram of a management information file according to an embodiment;

FIG. 7 illustrates an operation log list according to an embodiment;

FIG. 8 is a flowchart illustrating a file/directory creation process according to an embodiment;

FIG. 9 is a flowchart illustrating a file update process according to an embodiment;

FIG. 10 is a flowchart illustrating a file reference process according to an embodiment;

FIG. 11 is a flowchart illustrating a file migration process according to an embodiment;

FIG. 12 is a flowchart illustrating a directory migration process according to an embodiment;

FIG. 13 is a flowchart illustrating a file stubbing process according to an embodiment;

FIG. 14 is a flowchart illustrating a consistency recovery process according to an embodiment; and

FIG. 15 is a flowchart illustrating a management information file recovery process according to an embodiment;

### DETAILED DESCRIPTION

The description below explains the embodiments with reference to the accompanying drawings. The embodiments explained below do not limit the invention according to the scope of patent claims. All the elements and combinations thereof explained in the embodiments are not necessarily required for means to solve the problems of the invention.

The description below may explain information in the form of an “AAA list.” However, the information may be represented in any data structure. The “AAA list” can be represented as “AAA information” to show that the information is independent of data structures.

In the description below, a “processor” may represent one or more processors. At least one processor may typically represent a microprocessor such as a CPU (Central Processing Unit) or other types of a processor such as a GPU (Graphics Processing Unit). At least one processor may represent a single-core processor or multi-core processor.

The description below may explain a “program” as the subject of processes. The program is executed by a processor such as a CPU to perform predetermined processes while appropriately using a storage portion (such as memory) and/or an interface device. Therefore, the operational subject of processes may be assumed to be the processor (or a device or a system provided with the processor). The processor may include a hardware circuit that performs all or part of processes. The program may be installed from a program source on a device such as a calculator. The program source may be a program distribution server or a computer-readable recording medium (such as a portable recording medium), for example. In the following description, two or more programs may be implemented as one program, or one program may be implemented as two or more programs.

In the description below, reference symbols (or common symbols thereof) may be used to explain the same type of elements with no distinction. Identification numbers (or reference symbols) may be used to explain the same type of elements apart.

The description below outlines the processes of the file storage system according to an embodiment.

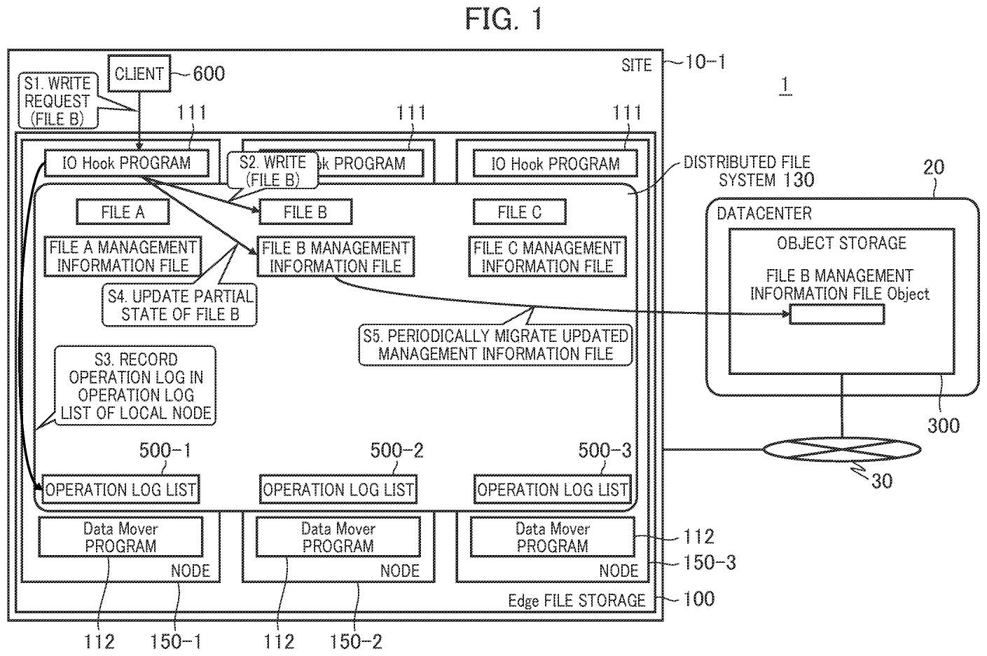

FIG. 1 illustrates an overview of normal processing of the file storage system according to an embodiment.

A site 10-1 includes Edge file storage (first storage system) 100. The Edge file storage 100 includes multiple nodes 150 (such as nodes 150-1, 150-2, and 150-3).

The Edge file storage 100 includes a distributed file system 130 that provides a client 600 with a file sharing service. The Edge file storage 100 can perform operations on files and directories as elements in the distributed file system 130.

The node 150 configuring the Edge file storage 100 includes an IO Hook program 111 and a Data Mover program 112 and provides the file sharing service. The IO Hook program 111 detects operations on files and directories stored in the distributed file system 130 and records operation logs in an operation log list 500 (500-1, 500-2, and 500-3) corresponding to each node 150. According to the present embodiment, the operation log list 500 is stored in the distributed file system 130. The IO Hook program 111 stores a management information file 400 corresponding to the files and directories in the distributed file system 130.

The Data Mover program 112 transfers files and directories detected by the IO Hook program 111 to object storage (second storage system) 300 of a datacenter 20. The transfer aims at backup and archiving, for example. The Data Mover program 112 records an operation log in the operation log list 500 corresponding to each node 150. This time, the operation log indicates that the migration operation was performed on the object storage 300. The Data Mover program 112 performs a stubbing process that deletes data of a file migrated to the object storage 300 from the Edge file storage 100. Similarly, the Data Mover program 112 records an operation log in the operation log list 500 for each node 150. This time, the operation log indicates that the stubbing operation has been performed

The description below explains an overview of the normal processing of the file storage system. In this process, the node 150-1 accepts an operation instruction on files in the Edge file storage 100 from the client 600. In FIG. 1, the operation instruction is a write request (data update) on file B in the distributed file system 130 of the Edge file storage 100.

The node 150-1 of the Edge file storage 100 accepts a write request from the client 600 on file B of the file system 130 in the Edge file storage 100 (S1). The IO Hook program 111 then detects the data update on file B and allows the distributed file system 130 to perform the data update on file B (S2) and records an operation log corresponding to the file update on file B in the operation log list 500-1 corresponding to the local node (node 150-1) (S3).

The IO Hook program 111 then changes the partial state of a range of updating file B in the management information file 400 for file B based on the contents of the data update (S4).

For example, the Data Mover program 112 periodically migrates the management information file 400 to the object storage 300 in the datacenter 20 (S5).

The above-described process stores the operation log indicating the contents of the operation instruction on the file in the operation log list 500 corresponding to the node 150 that received the operation instruction. The management information file 400 corresponding to each file is periodically migrated to the object storage 300.

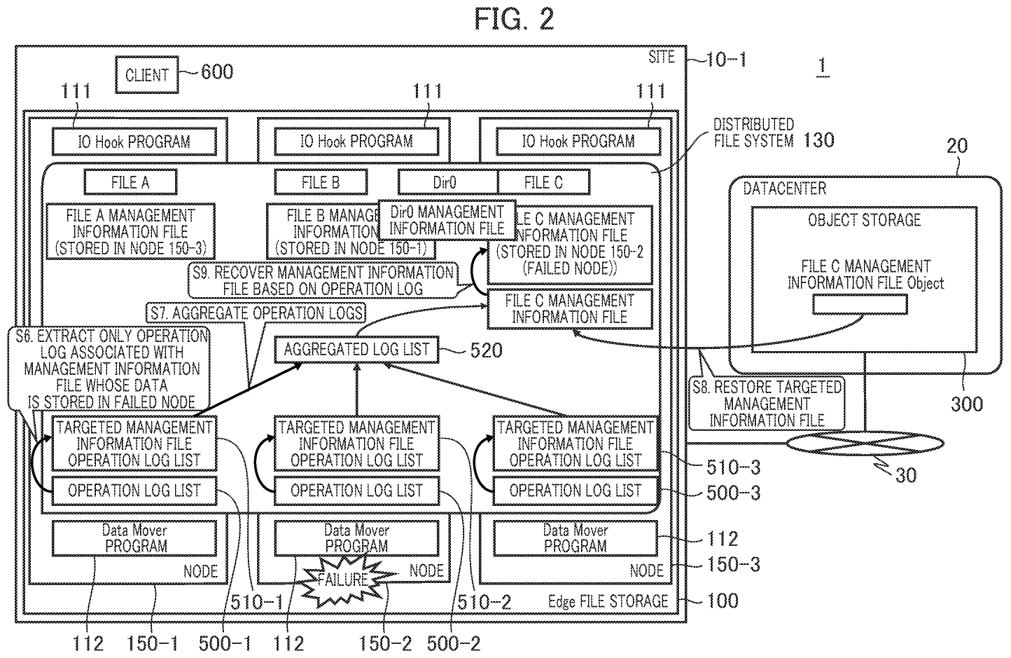

FIG. 2 illustrates an overview of processing during a failure recovery of the file storage system according to an embodiment. The process illustrated in FIG. 2 occurs after a failure occurred at the node 150-2, the node 150-2 was thereafter recovered from the failure, and the data recovery is complete up to the block layer of the distributed file system 130.

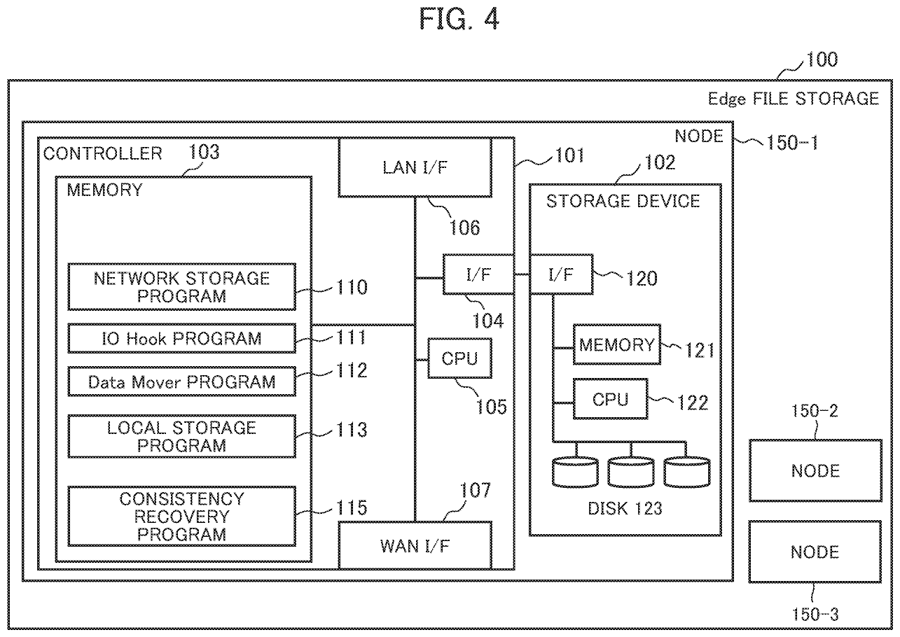

Suppose the failure recovery is mainly applied to a given node 150 or a failed node 150 such as the node 150-2 in the example of FIG. 2. The consistency recovery program 115 (see FIG. 4) for this node 150 requests each node to provide the operation log for a user file corresponding to the management information file 400 (targeted management information file). Data of the management information file 400 is stored in a storage device of the failed node 150-2. Then, the consistency recovery program 115 of each node 150 extracts the operation log for the user file corresponding to the targeted management information file from the operation log list 500 corresponding to the node 150 and generates a targeted management information file operation log list 510 (510-1, 510-2, and 510-3) (S6).

The consistency recovery program 115 for each node 150 then transmits the targeted management information file operation log list 510 to the node 150-2. The consistency recovery program 115 for the node 150-2 aggregates the targeted management information file operation log list 510 received from each received node 150 to generate an aggregated log list 520 (S7).

The consistency recovery program 115 for the node 150-2 then restores the targeted management information file based on the targeted management information file stored in the object storage 300 at a given time (S8). The consistency recovery program 115 recovers this targeted management information file by reflecting the operation log in the aggregated log list 520 in the targeted management information file and stores the targeted management information file in the node 150-2 (failed node) (S9).

The above-described process enables the targeted management information file 400 to be restored to a state consistent with the user file state and to be stored in the failed node. Consequently, it is possible to appropriately perform operations from the client 600 on the user file corresponding to the management information file 400 stored in the failed node.

The description below explains a file storage system 1 in detail.

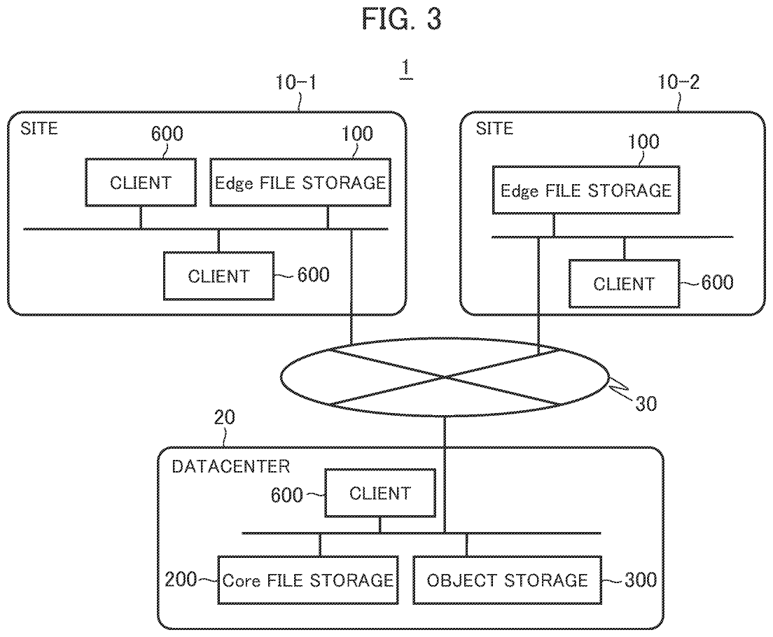

FIG. 3 illustrates a configuration diagram of the file storage system according to an embodiment.

The file storage system 1 includes multiple sites 10-1 and 10-2 and the datacenter 20. The sites 10-1 and 10-2 and the datacenter 20 are connected via a network 30.

The sites 10-1 and 10-2 each include at least one client 600 and at least one Edge file storage 100. The datacenter 20 includes at least one client 600, at least one Core file storage 200, and at least one object storage 300.

In each of the sites 10-1 and 10-2, the client 600 and the Edge file storage 100 are connected via a network such as LAN (Local Area Network). The client 600 uses the distributed file system 130 supplied from the Edge file storage 100 by using a file-sharing protocol such as NFS (Network File System) or CIFS (Common Internet File System).

In the datacenter 20, the client 600, the Core file storage 200, and the object storage 300 are connected via a network such as a LAN.

The network 30 is available as WAN (Wide Area Network), for example. Each Edge file storage 100 accesses the Core file storage 200 and the object storage 300 via the network 30 by using a protocol such as HTTP (Hypertext Transfer Protocol). The network 30 is not limited thereto and various networks can be used.

The present embodiment describes the example of deploying two sites 10-1 and 10-2 in the file storage system 1. However, the file storage system 1 may include any number of sites.

FIG. 4 illustrates a configuration diagram of the Edge file storage according to an embodiment.

The Edge file storage 100 includes multiple nodes 150 (such as nodes 150-1, 150-2, and 150-3).

The node 150 includes a controller 101 and a storage device 102. The controller 101 includes memory 103, a CPU 105, network interfaces (I/Fs) 106 and 107, and an interface (I/F) 104. These configurations are mutually connected by a communication path such as a bus.

The CPU 105 executes a program stored in the memory 103 and controls the overall operations of the controller 101 and the node 150. The network I/F 106 communicates with the client 600 via the network within the site 10. The network I/F 107 communicates with the data center 20 and devices in the other sites 10 via the network 30. The I/F 104 communicates with the storage device 102. The network I/F 106 or 107 may communicate with the other nodes 150 in the Edge file storage 100.

The memory 103 is available as RAM (Random Access Memory), for example, and stores programs and information to control the Edge file storage 100. Specifically, the memory 103 stores the network storage program 110, the IO Hook program 111, the Data Mover program 112, the local storage program 113, and the consistency recovery program 115. The programs and information stored in the memory 103 may be stored in the storage device 102 and may be read into the memory 103 by the CPU 105 for execution.

The network storage program 110 is executed by the CPU 105 to accept various requests such as Read/Write on files (user files) from the client 600, for example, and process protocols included in the requests. For example, the network storage program 110 processes the protocols such as NFS (Network File System), CIFS (Common Internet File System), and HTTP (HyperText Transfer Protocol).

The IO Hook program 111 is executed by the CPU 105 to detect operations on files and directories stored by the network storage program 110 in the distributed file system 130. The Data Mover program 112 is executed by the CPU 105 to migrate (transfer) directories and files detected by the IO Hook program 111 to the object storage 300.

The local storage program 113 is executed by the CPU 105 to provide the distributed file system 130. The local storage program 113 cooperates with local storage programs 113 for the other nodes 150 in the Edge file storage 100 to provide the distributed file system 130.

The consistency recovery program 115 is executed by the CPU 105 to perform a consistency recovery process to recover from the inconsistency between a file and the management information file managing the state or partial state of the file. The inconsistency between the file and the management information file is likely to occur when a failure such as a power failure occurs on the node 150, for example.

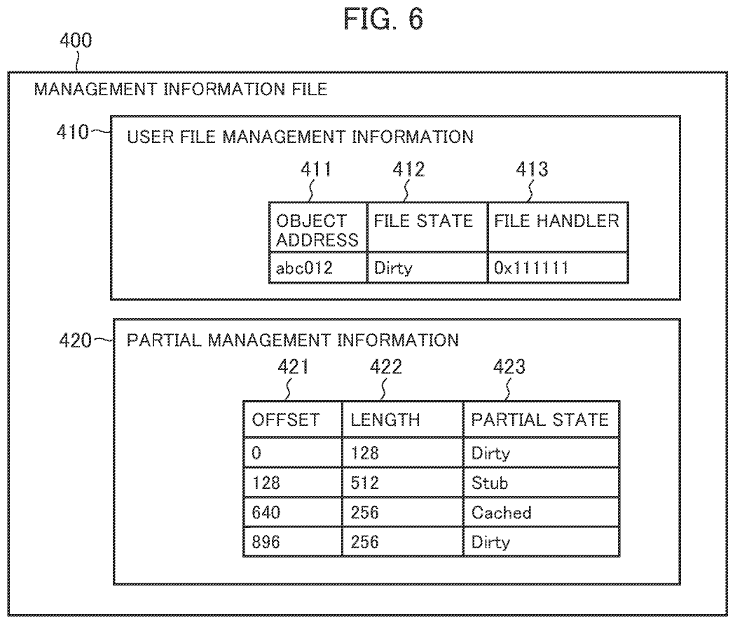

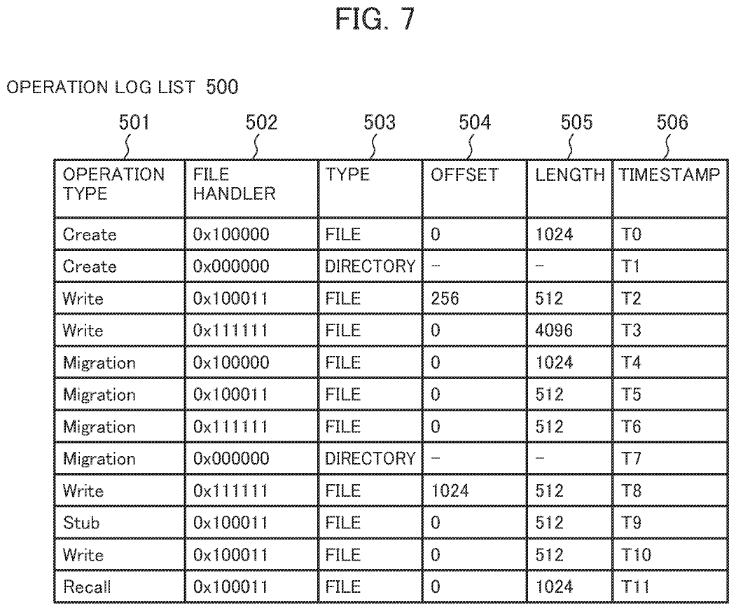

The storage device 102 includes an I/F 120, memory 121, a CPU 122, and a disk 123. These configurations are mutually connected by a communication path such as a bus. The I/F 120 provides an interface used for connection to the controller 101. The memory 121 is available as RAM, for example, and temporarily stores programs and data to control the storage device 102. The disk 123 is available as a hard disk or flash memory, for example, and stores various files including user files used by users of the client 600. The disk 123 stores the management information file 400 (see FIG. 6) and the operation log list 500 (see FIG. 7) to manage the states of user files. The CPU 122 executes a program in the memory 121 based on instructions from the controller 101. The storage device 102 may provide the controller 101 with a block-type storage function such as FC-SAN (Fibre Channel Storage Area Network).

The Core file storage 200 is configured equally to the Edge file storage 100, and illustrations and descriptions will be omitted for brevity.

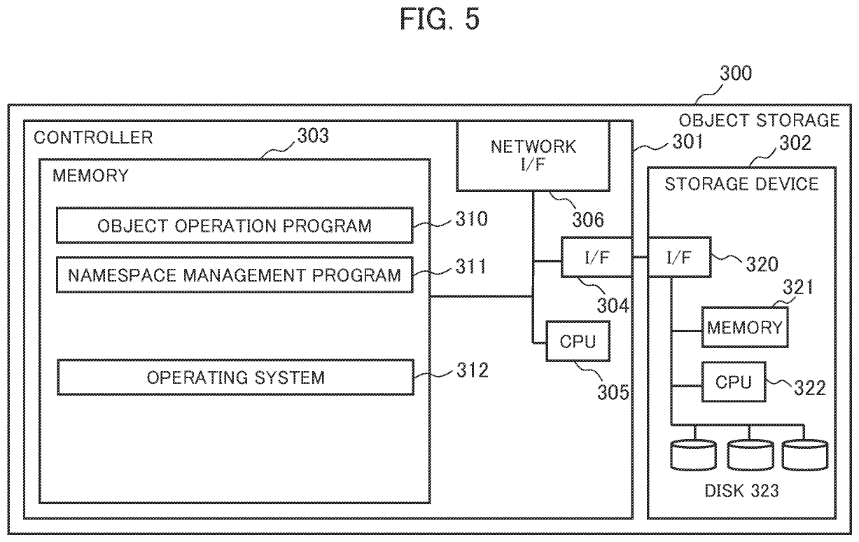

FIG. 5 illustrates an configuration diagram of the object storage according to an embodiment;

The object storage 300 includes a controller 301 and a storage device 302. The controller 301 includes memory 303, a CPU 305, a network I/F 306, and an I/F 304. These configurations are mutually connected by a communication path such as a bus.

The CPU 305 executes programs stored in the memory 303. The network I/F 306 provides an interface for communicating with the Core file storage 200 via a network in the data center 20 or communicating with the Edge file storage 100 of each site 150 via the network 30. The I/F 304 provides an interface for communicating with the storage device 302.

The memory 303 is available as RAM, for example, and stores programs and data to control the object storage 300. Specifically, the memory 303 stores an object operation program 310, a namespace management program 311, and an operating system (OS) 312. The programs and data stored in the memory 303 may be stored in the storage device 302. In this case, the CPU 305 reads the program and data into the memory 303 for execution.

The object operation program 310 processes requests (such as PUT and GET requests) from the Edge file storage 100 or the Core file storage 200. The namespace management program 311 generates and manages namespaces.

The storage device 302 includes an I/F 320, memory 321, a CPU 322, and a disk 323. These configurations are mutually connected by a communication path such as a bus. The I/F 320 provides an interface to communicate with the controller 301. The memory 321 is available as RAM, for example, and temporarily stores programs and data to control the storage device 302. The disk 323 is available as a hard disk or flash memory, for example, and stores, for example, objects corresponding to files (user files) used by users of the client 600. The CPU 322 executes programs in the memory 321 based on instructions from the controller 301. The storage device 302 may provide the controller 301 with a block-type storage function such as FC-SAN.

FIG. 6 illustrates a configuration diagram of the management information file according to an embodiment;

The management information file 400 is generated corresponding to each user file stored in the Edge file storage 100. The storage device 102 to store the management information file 400 may belong to the node 150 storing the corresponding user file or may belong to another node 150. The management information file 400 contains user file management information 410 and partial management information 420.

The user file management information 410 contains an object address 411, a file state 412, and a file handler 413.

The object address 411 is assigned to the object storage 300 and indicates the location to store an object corresponding to the user file corresponding to the management information file 400. The present embodiment uses a naming convention to determine an object address of the management information file 400 in the object storage 300 based on the object address of the corresponding user file. Therefore, the object address of the management information file can be specified from the object address 411. The file state 412 indicates user file states. The file states include “Dirty,” “Cached,” and “Stub.” Dirty indicates that the user file contains difference data not reflected in the object storage 300. Cached indicates that data of the user file is stored in the Edge file storage 100. Stub indicates that at least part of the user file area is stubbed. The file handler 413 stores a handler to handle user files.

The partial management information 420 stores entries corresponding to parts of a user file that are updated or added, for example. The entries of the partial management information 420 include fields such as offset 421, length 422, and partial state 423.

The offset 421 stores the start position (offset) of a part corresponding to the entry. The length 422 stores the data length from the start position of a part corresponding to the entry. The partial state 423 stores the partial state of a part corresponding to the entry. The partial state includes “Dirty,” “Cached,” and “Stub.” Dirty indicates that data of the part is not reflected in the object storage 300. Cached indicates that data of the part is stored in the Edge storage 100. Stub indicates that data of the part is stubbed.

FIG. 7 illustrates the operation log list according to an embodiment.

The operation log list 500 is provided in association with each node 150. According to the present embodiment, the operation log list 500 is managed by the distributed file system 130 and is not always stored in the storage device 102 of the node 150 corresponding to the operation log list 500.

The operation log list 500 stores entries (logs) for each operation. A log in the operation log list 500 contains fields such as operation type 501, file handler 502, type 503, offset 504, length 505, and timestamp 506.

The operation type 501 stores the operation type corresponding to the entry. The operation type includes Generate, Write (update), Migration, Stub, and Recall, for example. The file handler 502 stores the file handler of an operation-targeted file corresponding to the entry. The present embodiment uses a naming convention according to which the handler of the management information file 400 corresponding to a file appends a specified identifier to the handler of a user file. Therefore, the handler of the management information file 400 can be specified from a file handler corresponding to the file handler 502. The type 503 stores a value indicating the type, namely, file or directory, of an operation target corresponding to the entry.

The offset 504 stores the start position of part of an operation-targeted file corresponding to the entry. The length 505 stores the size of an operation-targeted part corresponding to the entry.

The timestamp 506 stores the timestamp to have performed an operation corresponding to the entry. According to the present embodiment, the timestamp 506 may be a pseudo timestamp capable of identifying the temporal relationship between the nodes 150. Instead of the pseudo timestamp, a counter value described below may be used as the timestamp 506.

The counter value indicates the number of times the Data Mover program 112 has migrated or stubbed a file since the file was generated. In this case, the management information file 400 corresponding to the file manages the counter value. The counter value unchangingly stores a counter value of the management information file 400 when the IO Hook program 111 performs operations such as generating, updating, or referencing files or updating or referencing metadata. When the operation is migration or stubbing, the counter value may store a value resulting from incrementing (by one, for example) the counter value of the management information file 400.

The targeted management information file operation log list 510 is similar to the aggregated log list 520 in terms of the operation log list 500 and the entry field configuration.

The description below explains in detail the processing operations of the file storage system 1 according to the present embodiment.

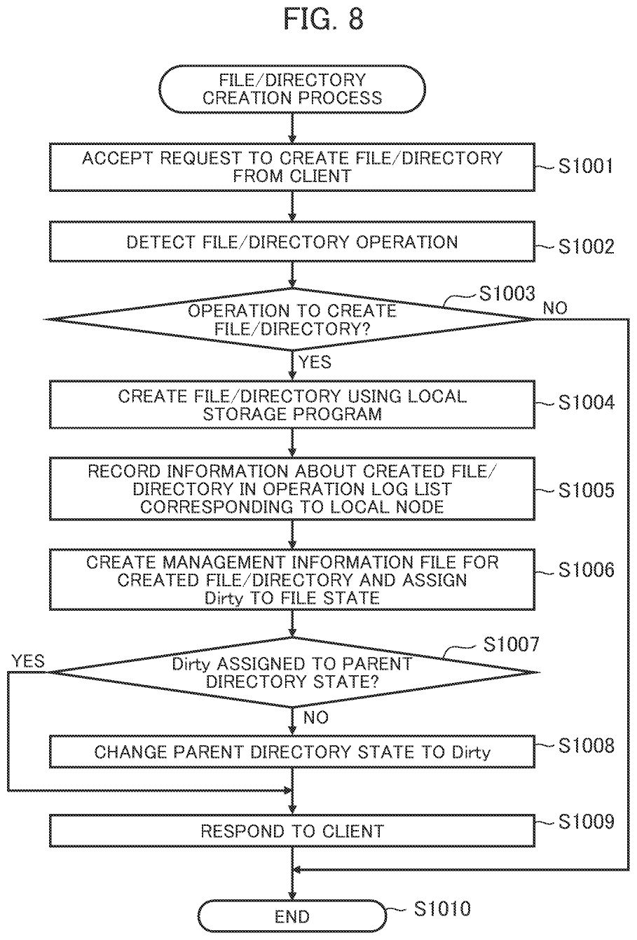

FIG. 8 is a flowchart illustrating a file/directory creation process according to an embodiment.

To perform the file/directory creation process, the CPU 105 of the controller 101 executes the network storage program 110 and the IO Hook program 111 on each Edge file storage 100.

The network storage program 110 accepts a file/directory creation request from the client 600 (S1001). The IO Hook program 111 detects a file/directory operation from the creation request accepted by the network storage program 110 (S1002).

Then, the IO Hook program 111 determines whether the operation is file/directory creation (S1003).

As a result, the operation may not be file/directory creation (S1003: No). Then, the IO Hook program 111 terminates the file/directory creation process.

The operation may be file/directory creation (S1003: Yes). Then, the IO Hook program 111 requests the local storage program 113 to create a file or directory. The local storage program 113 creates a file or directory in the distributed file system 130 (S1004).

At step S1004, the IO Hook program 111 requests the creation of a file or a directory whichever is targeted at the operation. The local storage program 113 creates a file or a directory in the distributed file system 130 according to the request.

Then, the IO Hook program 111 records the information (operation content) of the created file or directory in the operation log list 500 corresponding to the local node 150 (S1005). Zero is stored when a counter value is used as the timestamp 506.

The IO Hook program 111 then creates a management information file 400 corresponding to the created file or directory and assigns Dirty to the file state 412 of the user file management information 410 (S1006).

The IO Hook program 111 then determines whether the state of the parent directory of the created file or directory is Dirty (S1007).

As a result, Dirty may not be assigned to the state of the parent directory (S1007: No). Then, the IO Hook program 111 changes the file state 412 of the management information file 400 for the parent directory to Dirty (S1008) and proceeds to step S1009.

Dirty may be assigned to the state of the parent directory (S1007: Yes). Then, the process proceeds to step S1009.

At step S1009, the network storage program 110 responds to the client 600 to notify the completion of the file/directory creation and terminates the file/directory creation process.

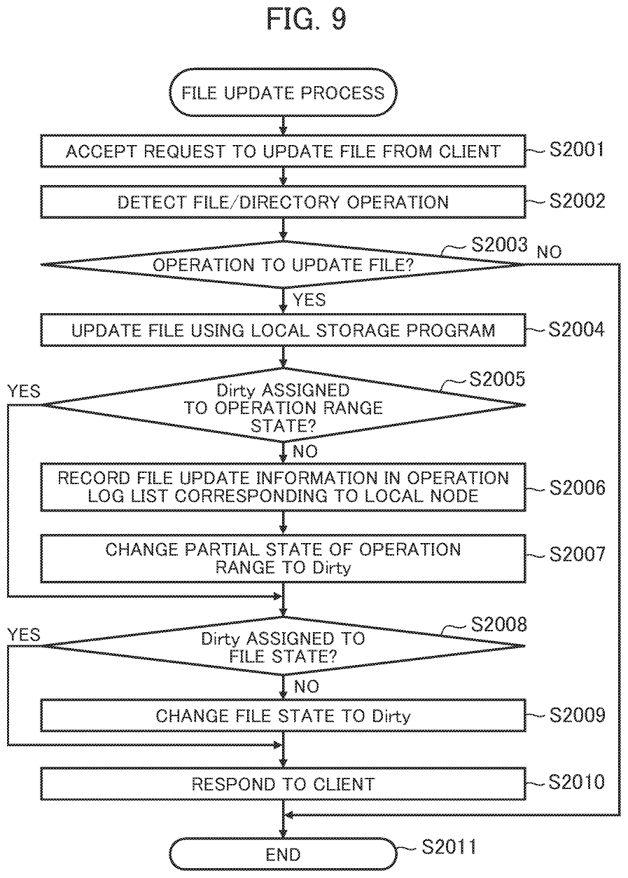

FIG. 9 is a flowchart illustrating a file update process according to an embodiment.

To perform the file update process, the CPU 105 of the controller 101 executes the network storage program 110 and the IO Hook program 111 on each Edge file storage 100.

The network storage program 110 accepts a file update request from the client 600 (S2001). The file update request includes requests such as updating and adding user file data, decompressing and compacting file data, changing a file owner/group or access rights, and updating metadata such as updating and adding extended attributes.

The IO Hook program 111 detects a file/directory operation from the file update request accepted by the network storage program 110 (S2002).

The IO Hook program 111 determines whether the detected operation is a file update (S2003).

As a result, the detected operation may not be a file update (S2003: No). Then, the IO Hook program 111 terminates the file update process.

The detected operation may be a file update (S2003: Yes). Then, the IO Hook program 111 requests the local storage program 113 to update the file. The local storage program 113 updates the requested file in the distributed file system 130 (S2004).

The IO Hook program 111 then references the management information file 400 and determines whether Dirty is assigned to the partial state of the updated part (operation range) of the file (S2005).

As a result, Dirty may not be assigned to the partial state of the updated part of the updated file (S2005: No). Then, the IO Hook program 111 records a log of this file update information in the operation log list 500 (S2006).

The IO Hook program 111 then changes the partial state 423 corresponding to the updated part of the management information file 400 to Dirty (S2007).

Dirty may be assigned to the partial state corresponding to the updated part of the file data of the updated file (S2005: Yes). Then, the IO Hook program 111 proceeds to step S2008.

At step S2008, the IO Hook program 111 references the management information file 400 to determine whether Dirty is assigned to the file state 412 of the updated file.

As a result, Dirty may not be assigned to the file state of the updated file (S2008: No). Then, the IO Hook program 111 changes the file state 412 of the management information file 400 to Dirty (S2009).

Dirty may be assigned to the file state of the updated file (S2008: Yes). Then, the IO Hook program 111 proceeds to step S2010.

At step S2010, the network storage program 110 responds to the client 600 to notify the completion of the file update and terminates the file update process.

The above-described file update process stores a log concerning the operation content of the updated file in the operation log list 500. Dirty is assigned to the state of the updated part and the updated file in the management information file 400, making it possible to identify the updated file and the updated part.

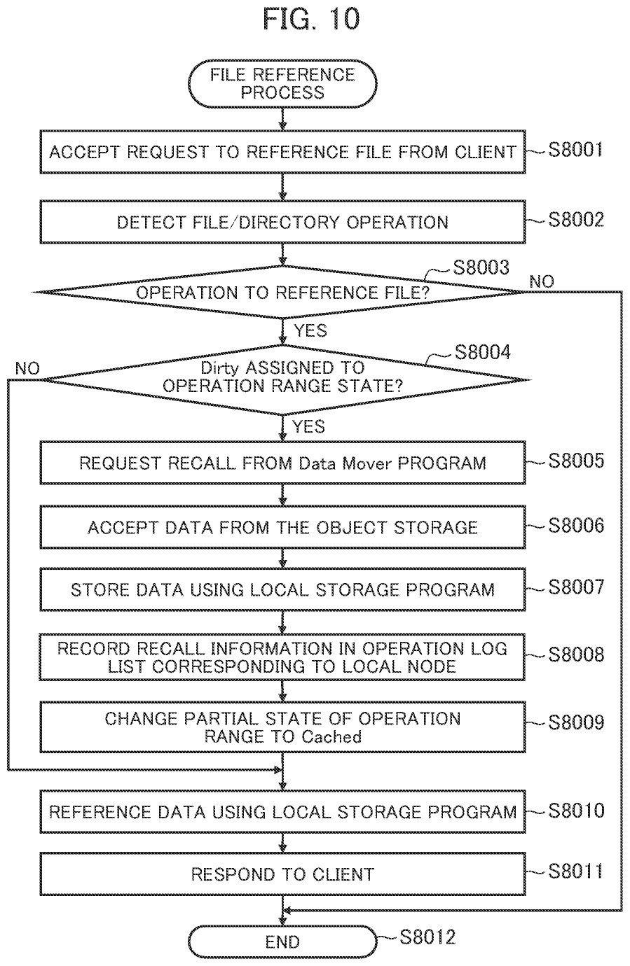

FIG. 10 is a flowchart illustrating a file reference process according to an embodiment.

To perform the file reference process, the CPU 105 of the controller 101 executes the network storage program 110, the IO Hook program 111, and the Data Mover program 112 on each Edge file storage 100.

The network storage program 110 accepts a file reference request from the client 600 (S8001).

Then, the IO Hook program 111 detects a file/directory operation from the file reference request accepted by the network storage program 110 (S8002).

The IO Hook program 111 determines whether the detected operation is a file reference (S8003).

As a result, the detected operation may not be a file reference (S8003: No). Then, the IO Hook program 111 terminates the file reference process.

The detected operation may be a file reference (S8003: Yes). Then, the IO Hook program 111 references the management information file 400 and determines whether Stub is assigned to the partial state of an operation-targeted range (operation range) (S8004). Stub is assumed if part of the operation range is stubbed.

As a result, Stub may not be assigned to the partial state of the operating range (S8004: No). Then, the IO Hook program 111 advances to step S8010.

Stub may be assigned to the partial state of the operating range (S8004: Yes). Then, the IO Hook program 111 requests a recall from the Data Mover program 112 (S8005). The recall is a process to acquire data from the object storage 300 when the data is not stored in the file system 130 of the Edge file storage 100.

The Data Mover program 112 requests the stubbed part of the data from the object storage 300 and accepts the corresponding data from the object storage 300 (S8006).

Then, the Data Mover program 112 allows the local storage program 113 to store the data in the distributed file system 130 (S8007).

The IO Hook program 111 records a log indicating the recall information in the operation log list 500 (S8008).

The IO Hook program 111 changes the partial state 423 of the operation range of the management information file 400 from Stub to Cached (S8009) and proceeds to step S8010.

At step S8010, the IO Hook program 111 allows the local storage program 113 to perform a file reference (S8010).

The IO Hook program 111 returns the referenced file as a response to the client 600 (S8011) and terminates the file reference process.

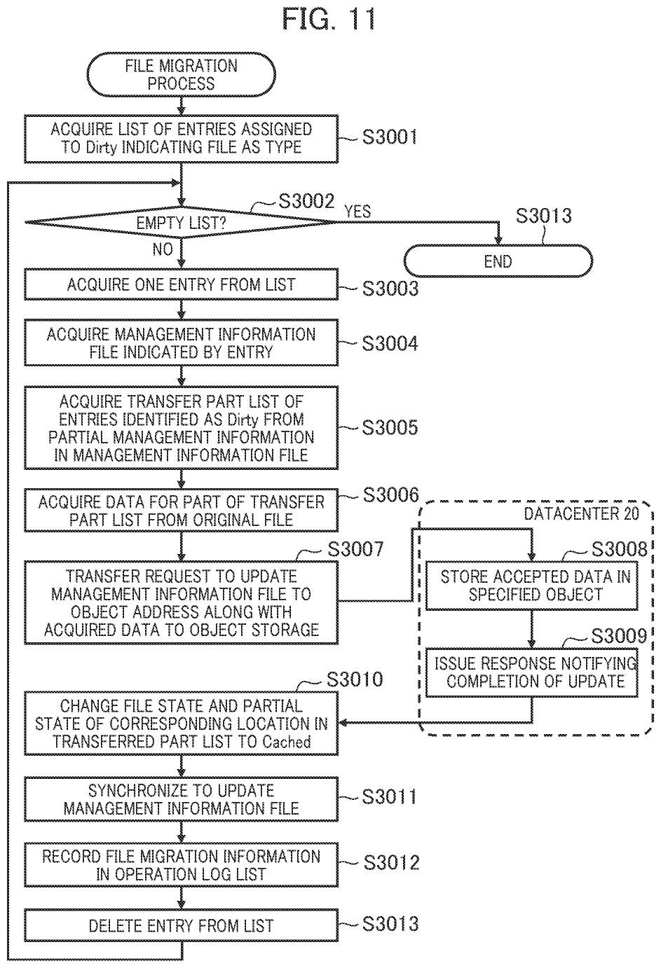

FIG. 11 is a flowchart illustrating a file migration process according to an embodiment.

To perform the file migration process, the CPU 105 of the controller 101 executes the Data Mover program 112 on each Edge file storage 100.

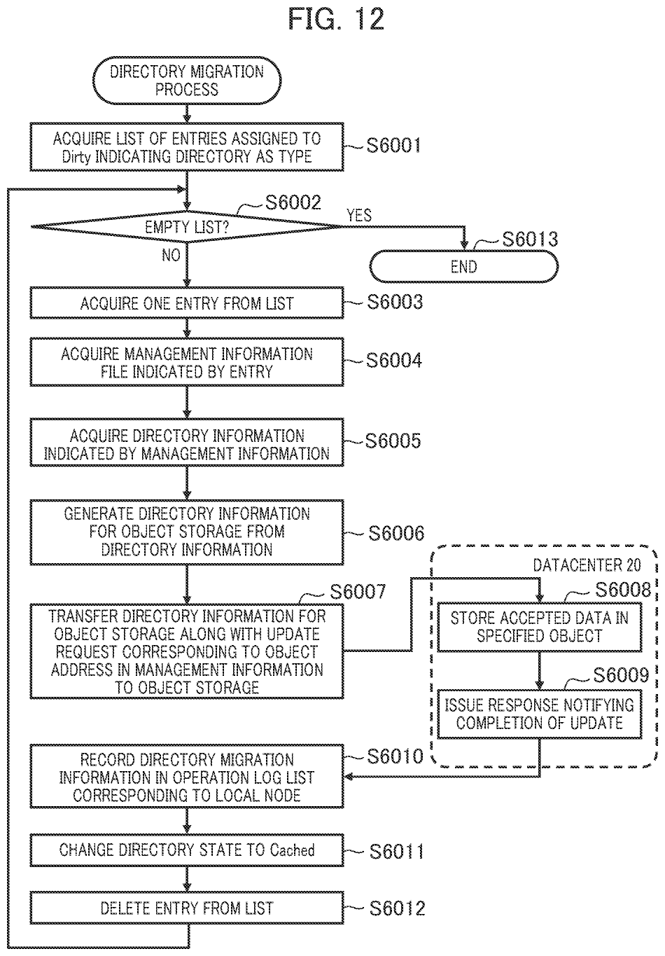

The file migration process may be performed when predetermined conditions are satisfied. For example, the file migration process may be performed periodically or irregularly, or when the client 600 operates on the distributed file system 130. The file migration process and a directory migration process to be described (see FIG. 12) may be performed sequentially or simultaneously.

The Data Mover program 112 acquires a list of entries indicating files that are stored in the distributed file system 130 and are identified as Dirty assigned to the file state 412 of the corresponding management information file 400 (S3001).

The Data Mover program 112 determines whether the acquired list is empty (S3002).

As a result, the list may be empty (S3002: Yes). Then, the Data Mover program 112 terminates the file migration process.

The list may not be empty (S3002: No). Then, the Data Mover program 112 acquires one entry from the list (S3003).

The Data Mover program 112 acquires the management information file 400 indicated by the acquired entry (S3004).

The Data Mover program 112 acquires a transfer part list of entries identified as Dirty assigned to the partial state 423 from the partial management information 420 in the acquired management information file 400 (S3005).

The Data Mover program 112 allows the local storage program 113 to acquire data corresponding to the entry in the transfer part list from the source file (S3006).

The Data Mover program 112 acquires the object address of an object corresponding to the file from the management information file 400 and transfers a request to update this object address along with the acquired data to the object storage 300 (S3007).

The object storage 300 accepts the update request from the Edge file storage 100, stores the accepted data at the specified object address (S3008), and issues a response notifying the completion of the update (S3009).

The Data Mover program 112 receives the response indicating the update completion and then changes the states by assigning Cached to the file state 412 of the management information file 400 for the file transferred to the object storage 300 and the partial state 423 of the transferred part (S3010). At this time, the counter value of the user file management information 410 is incremented (by one, for example) when the counter value is used as the timestamp in the operation log list 500.

The Data Mover program 112 updates the synchronization, assuming that the management information file 400 is completely synchronized (S3011).

The Data Mover program 112 records a log corresponding to the operation content of the file migration in the operation log list 500 corresponding to the local node 150 (S3012). When the counter value is managed as a timestamp, the counter value of the user file management information 410 is stored as the timestamp of the operation log list 500.

The Data Mover program 112 deletes the entry for the transferred file from the list (S3013) and proceeds to step S3002.

FIG. 12 is a flowchart illustrating a directory migration process according to an embodiment.

To perform the directory migration process, the CPU 105 of the controller 101 executes the Data Mover program 112 on each Edge file storage 100.

The directory migration process may be performed when predetermined conditions are satisfied. For example, the directory migration process may be performed periodically or irregularly, or when the client 600 operates on the distributed file system 130. The file migration process and the directory migration process may be performed sequentially or simultaneously.

The Data Mover program 112 acquires a list of entries indicating directories that are stored in the distributed file system 130 and are identified as Dirty assigned to the file state 412 of the corresponding management information file 400 (S6001).

The Data Mover program 112 determines whether the acquired list is empty (S6002).

As a result, the list may be empty (S6002: Yes). Then, the Data Mover program 112 terminates the directory migration process.

The list may not be empty (S6002: No). Then, the Data Mover program 112 acquires one entry from the list (S6003).

The Data Mover program 112 acquires the management information file 400 corresponding to the acquired entry (S6004).

Then, the Data Mover program 112 acquires the directory information from the acquired management information file (S6005). The directory information contains directory metadata and directory entry information about this directory. The directory entry information contains names and object addresses of the subordinate files or directories.

Then, the Data Mover program 112 generates directory information for the object storage from the acquired directory information (S6006).

The Data Mover program 112 acquires the object address of an object corresponding to the directory information from the management information file 400 and transfers a request to update this object address along with the directory information for the object storage to the object storage 300 (S6007).

The object storage 300 accepts the update request from the Edge file storage 100, stores (updates) the received directory information for the object storage corresponding to the specified object address (S6008), and responds to notify the completion of the update (S6009).

The Data Mover program 112 receives the response notifying the completion of the update and records a log indicating the operation contents of the directory migration information in the operation log list 500 (S6010).

The Data Mover program 112 changes the file state by assigning Cached to the file state 412 of the management information file 400 corresponding to the transferred directory (S6011).

The Data Mover program 112 deletes the transferred directory entry from the list (S6012) and proceeds to step S6002.

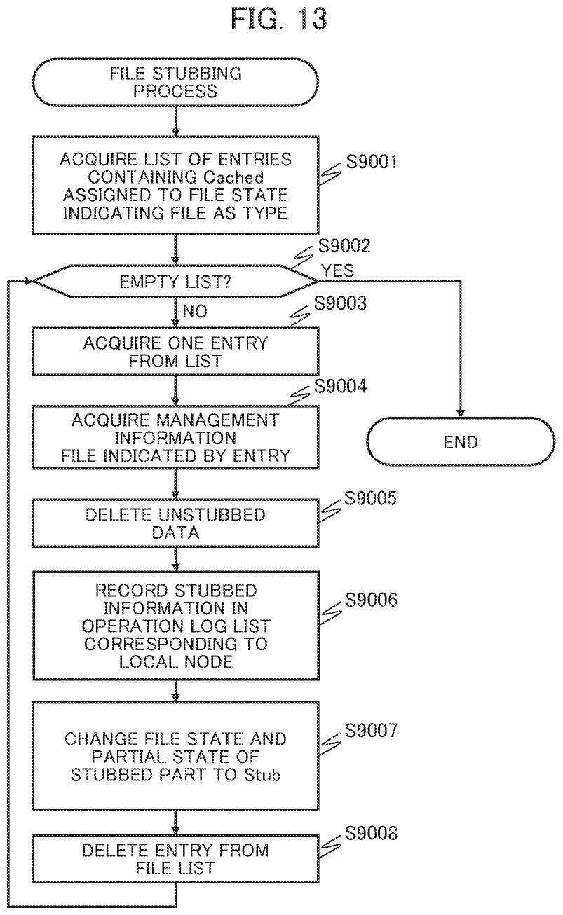

FIG. 13 is a flowchart illustrating a file stubbing process according to an embodiment;

The file stubbing process deletes, from the Edge file storage 100, data of a file that maintains the file state 412 assigned to Cached and is migrated to the object storage 300. The file stubbing process changes the file state 412 to Stub.

To perform the file stubbing process, the CPU 105 of the controller 101 executes the Data Mover program 112 on each Edge file storage 100.

The file stubbing process may be performed when predetermined conditions are satisfied. For example, the file stubbing process may be performed periodically or irregularly, or when the client 600 operates on the distributed file system 130. The file migration process, the directory migration process, and the file stubbing process may be performed sequentially or simultaneously.

During the file stubbing process, the Data Mover program 112 acquires a list of entries of files each of which includes the file state 412 assigned to Cached (step S9001).

At this step, files satisfying the conditions may be acquired by using any of the methods such as crawling through the distributed file system 130, extracting the files from the operation log list 500, and extracting the files from a database that manages the file system operation information.

The Data Mover program 112 determines whether the list is empty (S9002).

As a result, the list may be empty (S9002: Yes). Then, the Data Mover program 112 terminates the file stubbing process.

The list may not be empty (S9002: No). Then, the Data Mover program 112 acquires one entry from the list (S9003).

The Data Mover program 112 acquires the management information file 400 indicated by the acquired entry (S9004). Then, the Data Mover program 112 references the acquired management information file 400 and deletes unstubbed data from the Edge file storage 100 (step S9005). The unstubbed data is identified by the partial state 423 not indicating Stub.

The Data Mover program 112 records a log (stubbed information) indicating the stubbed operation content in the operation log list 500 corresponding to the local node 150 (S9006). At this time, the counter value of the user file management information 410 is incremented (by one, for example) and stored when the counter value is used as the timestamp 506 in the operation log list 500.

The Data Mover program 112 then changes the file state 412 of the management information file 400 for the stubbed file from Cached to Stub and changes the partial state 423 corresponding to part of the file deprived of data from Cached to Stub (S9007). The counter value of the user file management information 410 is incremented (by one, for example) when the counter value is used as the timestamp.

Then, the Data Mover program 112 deletes the entry from the list (step S9008) and proceeds to step S9002.

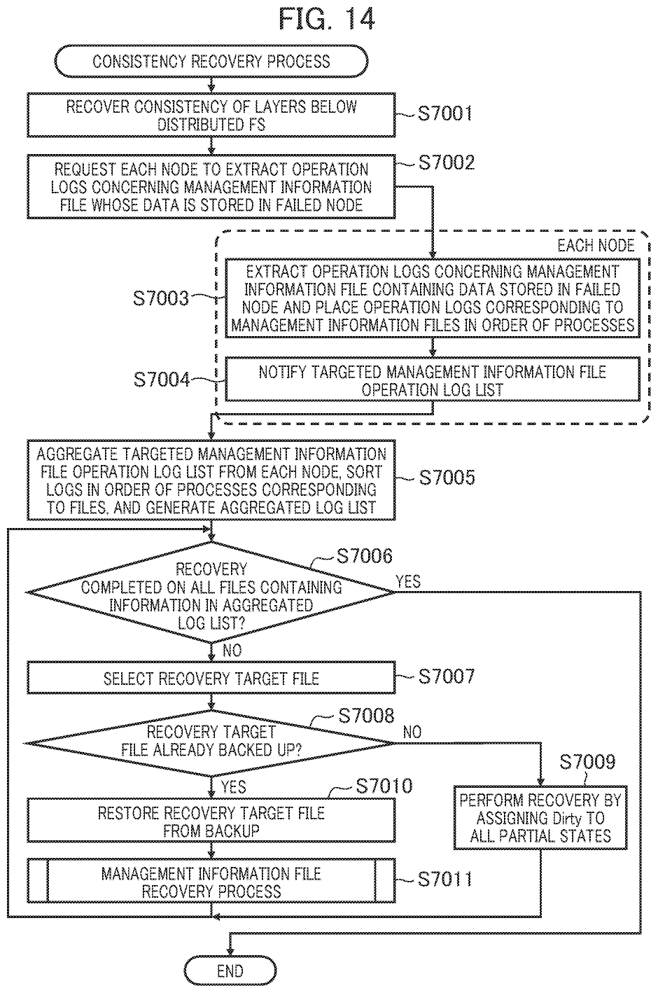

FIG. 14 is a flowchart illustrating a consistency recovery process according to an embodiment.

The consistency recovery process references the operation log list 500 and restores consistency between the management information file 400 and user files. To perform the consistency recovery process, the CPU 105 of the controller 101 executes the consistency recovery program 115 on the Edge file storage 100. Any one of nodes 150 represented as a main node in the Edge file storage 100 may perform the process at S7001, S7002, and S7005 through S7011 described later in the consistency recovery process. The main node 150 may correspond to the node 150 recovered from a failure.

The consistency recovery process may be performed when predetermined conditions are satisfied. For example, the consistency recovery process may be performed after the node 150 is recovered from a failure such as a power failure and is started. The consistency recovery process may be performed periodically or irregularly, or when the client 600 operates on the distributed file system 130.

The consistency recovery program 115 recovers the consistency of layers below the distributed file system (distributed FS) 130 (S7001). The layers include a block layer that manages data configuring a file as blocks, for example. The integrity of the block layer can be recovered by a known function of the block storage system used for the distributed file system 130.

Then, the consistency recovery program 115 requests each node 150 to extract operation logs for the management information file 400 whose data is stored in the node 150 (also called a failed node in this process) suffered from a failure (S7002). The request includes an instruction to extract the information to identify the failed node and the operation log of the management information file whose data was stored in the failed node. The extraction request may be targeted at operation logs collected after the previous file migration process. Whether operation logs are collected after the previous file migration process may be identified as follows. Information about the previous file migration process may be stored in a predetermined area and used for identification. Alternatively, the identification may be based on a process interval of the file migration process that may be performed periodically.

In each node 150 requested to extract operation logs, the consistency recovery program 115 extracts operation logs concerning the management information file 400 containing data stored in the failed node from the operation log list 500 corresponding to the local node. The consistency recovery program 115 places the operation logs corresponding to the management information files in the order of processes to generate the targeted management information file operation log list 510 (S7003). There may be some methods to identify the management information file 400 whose data was stored in the failed node. For example, the consistency recovery program 115 acquires information (such as algorithms) to identify the node 150 storing the management information file 400 from the local storage program 113. Based on that information, the consistency recovery program 115 may determine whether the management information file 400 was stored in the failed node. Alternatively, the consistency recovery program 115 makes an inquiry at the local storage program 113 about the node 150 that stores the management information file 400. Based on the inquiry result, the consistency recovery program 115 may determine whether the management information file 400 was stored in the failed node 150.

The targeted management information file operation log list 510 is limited to operation logs concerning the management information file 400 whose data was stored in the failed node. It is possible to significantly reduce the amount of data compared to the operation log list 500.

Then, the consistency recovery program 115 of each node 150 notifies (transmits) the targeted management information file operation log list 510 to the requesting node 150 (S7004). The targeted management information file operation log list 510 contains a smaller amount of data than the operation log list 500. The transmission time can be shortened and the processing load can be reduced.

Then, the consistency recovery program 115 aggregates the targeted management information file operation log list 510 from each node 150, sorts the logs in the order of processes corresponding to the management information files, and generates the aggregated log list 520 (S7005). The targeted management information file operation log list 510 transmitted from each node 150 contains the logs that are arranged in the order of processes corresponding to the management information files. A relatively simple process can fast sort the logs in the order of processes corresponding to the management information files.

The consistency recovery program 115 determines whether all the management information files 400 containing logs of the files corresponding to the aggregated log list 520 are completely recovered (S7006).

As a result, all the management information files 400 corresponding to the logs contained in the aggregated log list 520 may be completely recovered (S7006: Yes). Then, the consistency recovery program 115 terminates the consistency recovery process.

All the management information files 400 corresponding to the logs contained in the aggregated log list 520 may not be completely recovered (S7006: No). Then, one management information file (recovery target file) to be processed is selected from the incompletely recovered management information file 400 (S7007).

Then, the consistency recovery program 115 determines whether the recovery target file is already backed up, namely, migrated to the object storage 300 (S7008).

As a result, the recovery target file may not be backed up (S7008: No). Then, the consistency recovery program 115 recovers the recovery target file by assigning Dirty to all the corresponding partial states 423 in the recovery target file (S7009) and terminates the consistency recovery process.

The recovery target file may be backed up (S7008: Yes). Then, the consistency recovery program 115 acquires backup data for the recovery target file from the object storage 300 and restores the recovery target file to the backup state (S7010).

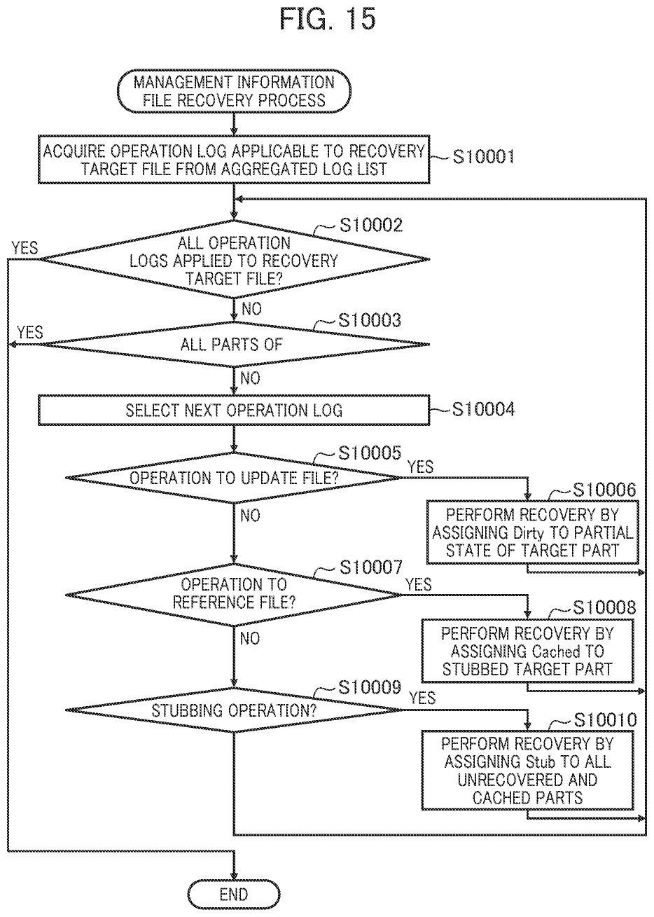

Then, the consistency recovery program 115 executes a management information file recovery process (see FIG. 15) that recovers the restored recovery target file to the latest state (S7011), and proceeds to step S7006.

FIG. 15 is a flowchart illustrating the management information file recovery process according to an embodiment.

The management information file recovery process corresponds to step S7011 of the consistency recovery process illustrated in FIG. 14.

The consistency recovery program 115 acquires all operation logs applicable to the recovery target file from the aggregated log list 520 (S10001).

Then, the consistency recovery program 115 determines whether all operation logs are applied to the recovery target file (S10002).

As a result, all the operation logs may be completely applied to the recovery target file (S10002: Yes). Then, the consistency recovery program 115 terminates the management information file recovery process. All the operation logs may not be completely applied to the recovery target file (S10002: No). Then, the consistency recovery program 115 advances to step S10003.

At step S10003, the consistency recovery program 115 determines whether all the partial states of the recovery target file are completely recovered. All the partial states of the recovery target file can be completely recovered when the recovery uses an operation log that updates the entire area of the file, for example.

As a result, all the partial states in the recovery target file may be completely recovered (S10003: Yes). Then, the consistency recovery program 115 terminates the management information file recovery process. All the partial states in the recovery target file may not be completely recovered (S10003: No). Then, the consistency recovery program 115 advances to step S10004.

At step S1004, the consistency recovery program 115 selects an operation log to be processed next from the acquired operation logs in chronological order of the processes.

The consistency recovery program 115 determines whether the content of the selected operation log is a file update operation (S10005). It may be determined that the content indicates a file update operation (S10005: Yes). Then, the consistency recovery program 115 performs the recovery by assigning Dirty to the partial state 423 for the corresponding part of the operation log in the recovery target file (management information file 400) (S10006) and proceeds to step S10002.

It may be determined that the content does not indicate a file update operation (S10005: No). Then, the consistency recovery program 115 determines whether the content of the selected operation log is a file reference operation (S10007). It may be determined that the content indicates a file reference operation (S10007: Yes). Then, the consistency recovery program 115 performs the recovery by changing the partial state from Stub to Cached for the corresponding part of the operation log in the recovery target file (management information file 400) (S10008) and proceeds to step S10002.

It may be determined that the content does not indicate a file reference operation (S10007: No). Then, the consistency recovery program 115 determines whether the content of the selected operation log is a stubbing operation (S10009). It may be determined that the content indicates a stubbing operation (S10007: Yes). Then, the process performs the recovery by assigning Stub to all unrecovered parts and the partial states 423 marked as Cached in the recovery target file (management information file 400) (S10010) and proceeds to step S10002. It may be determined that the content does not indicate a stubbing operation (S10007: No). Then, the process proceeds to step S10002.

The above-described management information file recovery process can recover the management information file to a state consistent with the corresponding file based on the operation logs. The process uses the aggregated log list 520 that is aggregated into only the operation logs corresponding to the management information files whose data is stored in the failed node. Therefore, it is possible to reduce the capacity required for the memory, reduce the processing loads, and shorten the processing time.

The present invention is not limited to the above-described embodiment and may be embodied in various modifications without departing from the spirit and scope of the invention.

For example, according to the above-described embodiment, the consistency recovery process at step S7003 allows each node 150 to place the operation logs corresponding to the files in the order of processes. However, the present invention is not limited thereto. For example, each node 150 may be replaced by the main node.

The consistency recovery process according to the above-described embodiment identifies a failed node as the main node to suppress loads on the fault-free nodes 150 and reduce influences on the user file input/output to/from unaffected user files from the client 600 using the fault-free node 150. However, the present invention is not limited thereto. For example, the main node may represent nodes other than the failed node.

The above-described embodiment may use the counter value as the timestamp in the operation log list 500. In this case, the consistency recovery process may extract only the operation log corresponding to the maximum counter value at step S7003 and may extract only the operation log corresponding to the maximum counter value in the targeted management information file operation log list to generate the aggregated log list at step S7005. Consequently, it is possible to reduce the number of operation logs used for the process, reduce the processing loads, and shorten the processing time.

The above-described embodiment migrates the management information file and the corresponding user file at the same time. However, the present invention is not limited thereto. For example, the management information file may be migrated more frequently than the user file. Consequently, it is possible to reduce the number of operation logs used to recover the management information file and shorten the processing time to recover the management information file.

The above-described embodiment migrates the management information file to the object storage 300. However, the present invention is not limited thereto. The management information file may be stored in the storage device 102 of any node 150, or more broadly, in a storage device accessible from the node 150.

According to the above-described embodiment, the failed node performs processes after the recovery from a failure. However, the present invention is not limited thereto. For example, an alternative node may be provided to perform processes in place of the failed node and may act as the above-described failed node.

The above-described embodiment may replace all or part of the processes performed by the processor with hardware circuits. The programs in the above-described embodiment may be installed from a program source. The program source may be available as a program distribution server or storage media (such as portable storage media).

What is claimed is:

1. A file storage system composed of a plurality of nodes each including a processor and a storage device, comprising:
a first storage system that manages a user file used by a client by distributing the user file to a plurality of nodes; and
a second storage system that is connected to the first storage system via a network and provides a file virtualization function for files managed by the first storage system in conjunction with the first storage system,
wherein the first storage system stores a user file and a management information file that manages a management state of the user file in the first storage system; and
wherein the first storage system
manages an operation log indicating operation contents of the user file accepted by each node in association with each node,
extracts, from each operation log corresponding to each node, an operation log for a user file corresponding to a targeted management information file as a management information file stored in a failed node, and
aggregates operation logs, being extracted from each operation log corresponding to each node and used for a user file associated with a targeted management information file, and recovers the targeted management information file based on an aggregated operation log.

2. The file storage system according to claim 1,
wherein a processor of each node in the first storage system extracts, from operation logs corresponding to a local node, an operation log for a user file associated with a targeted management information file as a management information file stored in a failed node and transmits the extracted operation log to a processor that recovers the targeted management information file.

3. The file storage system according to claim 1,
wherein the first storage system migrates the management information file to a predetermined storage device at a predetermined time point and
recovers the targeted management information file based on a management information file migrated at a predetermined time point and an aggregated operation log.

4. The file storage system according to claim 3,
wherein the first storage system recovers the targeted management information file while extracting and aggregating, from each operation log corresponding to each node, operation logs available at and after the predetermined time point for a user file associated with a targeted management information file as a management information file stored in a failed node.

5. The file storage system according to claim 3,
wherein the first storage system migrates the user file to the second storage system while migrating the management information file corresponding to the user file to the second storage system.

6. The file storage system according to claim 3,
wherein the first storage system migrates the management information file more frequently than the user file.

7. The file storage system according to claim 1,
wherein a processor of the failed node mainly performs a process of aggregating operation contents for a user file associated with the targeted management information file and recovering the targeted management information file based on aggregated operation contents.

8. A management information file recovery method used for a file storage system composed of a plurality of nodes each including a processor and a storage device, the file storage system including a first storage system that manages a user file used by a client by distributing the user file to a plurality of nodes; and a second storage system that is connected to the first storage system via a network and provides a file virtualization function for files managed by the first storage system in conjunction with the first storage system,
wherein the first storage system stores a user file and a management information file that manages a management state of the user file in the first storage system; and
wherein the first storage system
manages an operation log indicating operation contents of the user file accepted by each node in association with each node,
extracts, from each operation log corresponding to each node, an operation log for a user file corresponding to a targeted management information file as a management information file stored in a failed node, and
aggregates operation logs, being extracted from each operation log corresponding to each node and used for a user file associated with a targeted management information file, and recovers the targeted management information file based on an aggregated operation log.
